(19) United States
(12) Patent Application Publication
(10) Pub. No.: US 2012/0068109 A1
(43) Pub. Date: Mar. 22, 2012

(54) CATHODE MATERIAL FOR SECONDARY LITHIUM BATTERIES AND PREPARATION METHOD

(76) Inventor: Jay Jie Shi, Acton, MA (US)

(21) Appl. No.: 13/322,564

(22) PCT Filed: Aug. 27, 2009
(86) PCT No.: PCT/CN09/73579

§ 371 Date: Nov. 27, 2011

(30) Foreign Application Priority Data
Jun. 2, 2009 (CN) 200910052431.1

(51) Int. Cl. H01M 4/485; H01M 4/525

(52) U.S. Cl. 252/182.1

(57) ABSTRACT

In the invention, a cathode material for secondary lithium batteries was disclosed. It is a material with composite structures formed with more than two different components selected from a general formula [LiₐM_{1-y}M′_{y}O_{b}X_{c}]ₙ. The composite structures are formed between crystal clusters within primary particles and/or between primary particles. Methods for making such a cathode material were also disclosed in the invention. The cathode material has composite structures formed by compositing different components at nanometer level, which can integrate benefits of different components, resulting in better overall comprehensive properties.

### TECHNICAL FIELD

This invention is for a cathode material for secondary lithium batteries and the preparation method.

### TECHNICAL BACKGROUND

In a world with oil as major energy resources, development of alternative energy resources and energy saving technologies for reducing oil dependence has been an important policy due to the exhaustion of oil. The hybrid electric vehicle technologies, first successfully developed in Japan in 1990's, enable to reduce oil consumption and air pollution in vehicles. Currently, the batteries that are used in hybrid electric vehicles made by Toyota and Honda are nickel metal hydrate batteries, which have lower energy density than lithium-ion batteries. Using lithium-ion batteries will significantly reduce the gross weight of a hybrid electric vehicle or pure electric vehicle, leading to longer driving distance with a single charge.

Lithium-ion batteries have been widely used in portable and digital electronic devices, such as laptop computers, cellular phones, digital cameras, etc., due to their highest energy density among small secondary batteries. The requirements and demands for power batteries that used in hybrid electric vehicles, pure electrics and other electric transportation objects are different from those for used in portable electronic devices. The power batteries for vehicles need not only high energy density but also high power density, low cost, long life and good safety. Cathode materials in power lithium batteries play a critical role to determine whether or not a battery can meet the requirements and demands.

The major cathode materials for power lithium batteries in the marketplace or under development currently are lithium iron phosphate-based one-dimension structural materials, lithium cobalt oxide and doping modified lithium nickel oxide (including lithium nickel cobalt manganese oxide, lithium nickel manganese oxide) based layered structural materials and spinel lithium manganese oxide-based three-dimension structural materials (M. S. Whittingham, Chem. Rev. 104, 427 (2004)). Among them, the doping modified lithium nickel oxide-based materials have the high energy, high cyclability and low cost. However, they have lower thermal stability at fully charged state, which generates exothermic reactions and leads to lower battery safety. These cathode materials are problematic for application in power lithium batteries. Lithium nickel cobalt manganese oxide-based materials also have problems for use in power lithium batteries due to their high cobalt content, leading to high cost and limited cyclability. In order to remarkably increase the thermal stability of doping modified lithium nickel oxide-based materials, many methods have been employed in prior arts.

Using doping methods to modify the lithium nickel oxide structure to improve the material properties have been widely reported in literatures (C. Delmas and L. Croguenned, MRS Bulletin, August 2002, page 608; T. Ohzuku et al., J. Electrochem. Soc., 142, 4033 (1995); Y. Gao et al, Electrochem. & Solid-State Lett., 1, 117 (1998)). Although doping with Al, Mg and Ti elements (LiNi₁₋ₓMₓO₂ or LiNi_{1-x-y}Co_{xM}_{y}O₂, 1-x-y>0.6, M=doping elements) could improve the thermal stability of materials to some extent, their thermal stability still has some problems and cannot meet the requirements for power lithium batteries (K. Amine et al, J. Electrochem. Soc., 153, A2030 (1996)). Incorporating large amount of electrochemically inactive Mn⁴⁺ ions in layered structures could have a big help to improve thermal stability of the materials. For example, Dahn et al and Ohzuku et al disclosed layered structural materials: Li(NiₓCo₁₋₂ₓMnₓ)O₂, 0≦x≦0.5 (Dahn et al, Electrochem. & Solid-State Lett., 4, A200 (2001); Z. Lu and J. Dahn, U.S. Pat. No. 6,964,828; T. Ohzuku et al, U.S. Pat. No. 6,551,744). The thermal stability of these materials is related to the values of x. When x=0.5, the thermal stability and cyclability of the material are the best. However, this material has low conductivity, and the specific capacity within the conventional lithium-ion battery charging range (2.7-4.2V) is low, just around 130-140 mAh/g. Ceder reported a nano LiNi_{0.5}Mn_{0.5}O₂ material (Ceder et al, Science, 311, 977 (2006)) with improved rate capability, but little improvement in specific capacity. When x=⅓, the specific capacity of the material within the conventional battery charging range (2.7-4.2V) reached 150-155 mAh/g. But its cost is high due to containing large amount cobalt element, and its thermal stability is still not sufficient. Thus this material has faced application hurdles in cost and safety for power lithium battery applications. In addition, LiNi_{0.6}Co_{0.05}M_{0.4}O₂ material has a specific capacity of 150 mAh/g within the conventional battery charging range (Li et al, IMLB 2008 Proceeding Abs#254). But its cyclability is not good enough. The atomic level doping can significantly alter overall property and performance of materials. Due to the interactions existing between atoms, the requirements for matching the electronic structures, energy levels and ionic radius between the main element atoms and doping element atoms are very strict.

Blending the lithium nickel oxide-based cathode materials with other cathode materials that have higher thermal stability could also improve the mixtures' thermal stability to some extent relative to the pure nickel oxide-based materials. Numata and Mayer reported cathode materials made by blending LiNi_{0.8}Co_{0.2}O₂ and LiMn₂O₄ cathode powders (Numata et al, J. Power Sources, 97-98, 358 (2001); Mayer, U.S. Pat. No. 6, 007,947). The thermal stability of the mixture was higher than LiNi_{0.8}Co_{0.2}O₂, and the cyclability is better than LiMn₂O₄. Sanyo Electrics also disclosed a cathode mixture in a patent of U.S. Pat. No. 6,818,351. Although physical blending method can improve some properties of the system, the improvements are limited due to the mixing is between the secondary particles of materials and the interactions between materials are long range, macroscopic physical interactions.

A so called Core-Shell structure material was disclosed (K. Sun et al, Electrochem. & Solid-State Lett., 9, A171 (2006); WO/2005/064715; Natural Materials, 8, 320(2009)). The core of this material is Li(Ni_{1-x-y}CoₓMn_{y})O₂, 1-y<0.7, and the shell is LiNi_{0.5}Mn_{0.5}O₂. The thermal stability and cyclability of this material were improved. The shell of this core-share material may be damaged during cycling, which lowers the cyclability and long term stability of the material. In addition, the rate capability of this material is low since the shell material has low conductivity.

Molecular level active-inactive composite materials with a general formula of xLi(Li_{1/3}Mn_{2/3})O₂-(1-x)Li(Ni_{y}Co_{1-2y}Mn_{y})O₂ (Thackeray et al, J. M 15, 2257 (2005)) can increase the thermal stability. This type of materials is prepared by self phase separation during sintering due to different physical interactions between different compositions. This type of materials has very low capacity within the conventional battery charging range (2.7-4.2V) due to the Li(Liᵥ₃Mn_{2/3})O₂ phase is electrochemically inactive below 4.4V. When charging to 4.8V, Li(Li_{1/3}Mn_{2/3})O₂ shows electrochemical activity leading to high specific capacity of the material. However, the high charging voltages have high demanding on electrolytes and other cell materials, which has no good solutions available currently. Since forming electrochemically active-inactive composites in the molecular lever-neither as doped material with a homogeneous structure nor macro-phase separation, the compatibility between different components is critical, which significantly limit selection of combinations of composition.

### SUMMARY OF INVENTION

The current invention is to provide a pathway to improve properties of cathode materials, in order to overcome disadvantages in prior arts, i.e., crystal structural doping method, method of physical mixing between materials and method of material phase separation. It also provides cathode materials and preparation techniques of these cathode materials for secondary lithium batteries. The cathode materials in the current invention have composite structures consisting of different components in a nanometer level, which can maintain benefits of each component while reducing their disadvantages to achieve better comprehensive functions. The cathode materials consisting of optimized different components can achieve effects of high energy density, high power density, higher thermal stability and safety, high cyclability and lower cost.

The current invention is through compositing crystal clusters within primary particles and/or compositing primary particles of two or more than two different components in a nanometer level, and forming secondary particles by agglomeration of these primary particle composites to achieve the above targets (Illustrated in FIG. 8).

The current invention involves a cathode material for secondary lithium batteries that has composite structures that are formed by composting more than two different components that have a general formula of (LiₐM_{1-y}M′_{y}O_{b}X_{c})ₙ. The said composite structures are structures formed compositing crystal clusters within primary particles and/or composting primary particles. Where M can be any one selected from Ni, Co, Mn, Ti, V, Fe and Cr; M′ can be any one selected from Mg, Al, Ca, Sr, Zr, Ni, Co, Mn, Ti, V, Fe, Cr, Zn, Cu, Si, Na and K or any combinations between two or more than two of them; X can be any one selected from F, S, N, P and Cl; 0.5≦a≦1.5, 0≦y≦0.1, 1≦b≦2.1, 0≦c≦0.5, 1≦n≦2.

The “component” in the current invention means substances in material composite structures with the same chemical compositions and crystal structures.

The better cathode materials are those materials with composite structures formed by composting more than two different components selected from following two general formulas.

The general formula for one component is Liₐ₁M1_{1-y1}M1′_{yl}O₂, where 0.95≦a1≦1.1, 0≦y1≦0.5; M1 is one of Ni, Co, Mn; M1′ is Co, Mn, Mg, Al, Ti and Zr or combinations of two or more than two of them. The better ones are: 0.95≦a1≦1.1, 0≦y1≦0.3; M1 is Ni; M1″ is Co_{i-z-m}Mn_{z}M1″ₘ, where M1′ is one of Mg, Al, Ti and Zr or combinations of two or more than two of them, 0≦z≦1, 0≦m≦1, 0≦z+m≦1.

The general formula for the other component is Liₐ₂M2_{1-y2}M2′_{y2}O₂, where M2 is one of Ni, Co, Mn, Ti, V, Fe and Cr; M2′ is one of Mg, Al, Ca, Sr, Zr, Ni, Co, Mn, Ti, V, Fe, Cr, Zn, Cu, Si, Na and K or combination of two or more than two of them; 0.5≦a2≦1.5, 0≦y2≦1. Better, M2 is Ni, M2′ is Mn₁₋ₙ₂M2″ₙ₂, where M2″ is one of Mg, Ti, Al and Zr or combinations of two or more than two of them, 0≦n2≦1, 0.95≦a≦1.1, 0.3<y2<0.8. Further better, 0.5≦y2≦0.7, 0≦n2≦0.5.

For the above cathode materials, the better molar ratio of components is 0≦Σ[Liₐ₂M2_{(1-y2)}M2′_{y2}O₂]/Σ[Liₐ₁M1_{(1-y1)}M1′_{y1}O₂]≦200, the further better 0.25≦Σ[Liₐ₂M2_{(1-y2)}M2′_{y2}O₂]/Σ[Liₐ₁M1_{(1-y1)}M1′_{y1}O₂]≦4, where Σ[Lₐ₂M2_{(1-y2)}M2′_{y2}O₂] is the total molar sum of components with a general formula of Liₐ₂M2_{(1-y2)}M2′_{y2}O₂, and Σ[Liₐ₁M1_{(1-y1)}M1′y1O₂] is the total molar sum of components with a general formula of Liₐ₁M1_{(1-y1)}M1′_{y1}O₂.

In the current invention, it is better that one or more components in the cathode material have high capacity in their independent state, while the cathode material is consisting of one or more components different from the high capacity components. For example, the high capacity component may have disadvantages in one or more properties in aspects such as thermal stability, cyclability and cost, etc. To compensate these disadvantages, the one or more different components are incorporated into the composite. These components in independent states may have lower capacity, even electrochemically inactive, but have better properties in aspects such as thermal stability, cyclability and cost, etc. In such composite structures, the comprehensive properties of the composite material are much better due to the interactions between the different components.

For instance, the better composite is consisting of two components: one is LiNi_{0.8}Co_{0.1}Mn_{0.1}O₂, which has a high capacity (>180 mAh/g) and good cyclability but low thermal stability in its independent state; the another is LiNi_{0.5}Mn_{0. 5}O₂ or LiNi_{0.45}Mg_{0.05}Mn_{0.5}O₂, which has low capacity (130-140 mAh/g) and low conductivity, but has high thermal stability and cyclability in its independent state. The optimized composite material 0.5LiNi_{0.8}Co_{0.1}Mn_{0.1}O₂-0.5LiNi_{0.5}Mn_{0.5}O₂ or 0.5LiNi_{0.8}Co_{0.1}Mn_{0.1}O₂-0.5LiNi_{0.45}Mg_{0.05}Mn_{0.5}O₂ has high thermal stability and conductivity while has high capacity and cyclability.

The investor found through studies that a precursor for preparation of the targeted cathode material has to be prepared first. The precursor has corresponding composite structures to the cathode material. These composite structures are formed by composting crystal clusters within primary particles and/or composting primary particles of different components in a nanometer level. The precursors include, but not limit to, transition metal hydroxides or carbonate salts. The precursor is prepared by individually precipitating metal salt solutions in alkaline solutions with different compositions (two metal salt solutions as example, written as I and II thereafter) to form metal hydroxide or metal carbonate crystal clusters. Before these crystal clusters have completely grown to primary particles or the crystal clusters have formed primary particles but these primary particles have not formed secondary particles, the suspensions with crystal clusters and/or primary particles formed from metal salt solution I and II are mixed to allow the growth of primary particles together, and these primary particles further grow to secondary particles. The molar ratio of metals that are in metal salt solutions I and II in the precursor determines the final molar ratio of metals in the final cathode material. The prepared precursor is mixed with other lithium element containing raw materials (such as lithium hydroxide or lithium carbonate). And the mixture is sintered under certain atmospheres and temperatures to achieve the target cathode material.

Thus, the current invention also involves preparation of precursors for the above cathode materials for secondary lithium batteries. The precursor is consisting of composite structures of more than two different components with a general formula of M_{(1-y)}M′_{y}(E)_{F}. Such composite structures are formed within primary particles and/or between primary particles. The definition of y, M, M′ is the same as in the previous description, and E is oxygen element containing anions that can form precipitates with M and M′, where F value is to keep the charge neutrality in the formula. It is better that E is the hydroxy anion or carbonate anion. When E is the hydroxy anion, F value equals to b, and the meaning of b is as described in the above.

It is further better that the precursor is AM1_{(1-y1)}M1′_{y1}(OH)_{b1}-(1−A)M2_{(1-y2)}M2′_{y2}(OH)_{b2}, where A is the molar ratio of M1_{(1-y1)}M1′_{y1}(OH)_{b1} the precursor , and 1−A is the molar ratio of M2_{(1-y2)}M2′_{y2}(OH)_{b2}component in the precursor, 0<A<1, 0<(1−A)/A≦200, with optimized 0.25≦(1−A)/A≦4; the meaning of b1 and b2 are the same as b described previously, and b1 and b2 can be the same or different, y1, y2, M1, M1′, M2 and M2′ have the same meanings as described previously.

Or, further better, the described precursor is AM1_{(1-y1)}M1^{′y1)}(CO₃)_{b1/2}-(1−A)M2_{(1-y2)}M2′_{y2}(CO₃)_{b2/2}, where A is the molar ratio of M1_{(1-y1)}M1_{′y1}(CO₃)_{b1/2} component in the precursor is the molar ratio of M2_{(1-y2)}M2′_{y2}(CO₃)_{b2/2}component in the precursor, 0≦A≦1, 0≦(1−A)/A≦200, with better 0.25≦(1−A)/A≦4; the meaning of b1 and b2 are same as b described in the above, b1 and b2 can be the same or different, b1/2 means half of b1 and b2/2 means half of b2, y1, y2, Ml, M1′, M2 and M2′ have the same meanings as described in the above.

The current invention also involves a method for preparation of precursors of the above cathode materials for secondary lithium batteries. It includes following procedures:

Select more than two different individual components according to the general formula of [LiₐM_{1-y}M′_{y}O_{b}X_{c}]ₙ, and then prepare hydroxides or carbonates that correspond to each individual components, where the hydroxides or carbonates of individual components are those hydroxides or carbonates consisting of M and M′ cations. When these hydroxides and carbonates in the stage of formation of crystal clusters and/or primary particles, mix them together and allow them to grow to primary particles and/or secondary particles together, and then get the precursor with the composite structures.

Among them, the better means to prepare hydroxides corresponding to each individual component are: mix the metal salt solutions, M salt and M′ salt solutions, for each individual component according to the general formula of [LiₐM_{1-y}M′_{y}O_{b}X_{c}]ₙ. Then, mix the salt solution with aqueous alkaline solution to take place participating reactions to form hydroxide corresponding to that individual component. The alkaline solution can be any hydroxide anion containing inorganic alkaline solutions that can take place precipitating reacts with the metal solutions. The better alkaline solution is alkali metal hydroxides;

Among them, the better means to prepare carbonates corresponding to each individual component are: mix the metal salt solutions, M salt and M′ salt solutions, for each individual component according to the general formula of [LiₐM_{1-y}M′_{y}O_{b}X_{c}]ₙ with alkaline carbonate solutions to take place participating reactions to form carbonates corresponding to that individual component.

More detailed description of process of this method is as follows: use two components in the cathode material as example. Mix salt solution of M¹ salt and M′¹ salt as presented in the formula of component 1 of [Li_{a′1}M¹_{(1-y′1})M′¹_{(1-y′1)}M′¹_{y′1}O_{b′1}X¹_{c′1}]_{n′1} and the salt mixture of solution M² salt and M′² salt as presented in the formula of component 2 of [Li_{a′2}M²_{(1-y′2})^{M′}²_{y′2}O_{b′2}X²_{c′2}]_{n′2} with alkaline solutions or alkaline carbonate solutions respectively to take place participating reactions to form hydroxides or carbonates. Mix these hydroxides or carbonates that are in stages of formation of crystal clusters and/or primary particles, and allow then to grow to primary particles and secondary particles together in the mother solution. The precursor is then obtained. Based on needs, if the cathode material contains multi components , such as [Li_{a′3}M³_{(1-y′3)}M′3_{y′2}O_{b′3}X³_{c′3}]_{n′3}, [Li_{a′4}M⁴_{(-y′4)}M′⁴_{y′4}O_{b′4}X⁴_{c′4}]_{n′4}, [Li_{a′5}, M⁵_{(1-y′5)}M′5_{y′5}O_{b′5}X⁵_{c′5}]_{n′5} and so on, it follows the similar process. In the above general formula, symbols a′1-a′5 have the same definition of previous described a, a′1-a′5 can be the same or different; similarly, y′1-y′5, b′1-b′5, c′1-c′5 and n′1-n′5 have the same definitions as y, b, c and n respectively described in above; the values of symbols with the same letter can be the same or different. Definitions of M¹, M², M³, M⁴, M⁵ . . . are the same as M described in the above; definitions of M′¹, M′², M′³, M′⁴, M′⁵, . . . are the same as M′ described in the above ; definitions of X¹, X², X³, X⁴, X⁵, . . . are the same as X described in the above; the values of symbols with the same letter can be the same or different.

Better, when the cathode material for secondary lithium batteries is made of composite structures consisting of different components with the general formula of Liₐ₁M1_{(1-y1)}M1′_{y1}O_{b1} and Liₐ₂M2_{(1-y2)}M2′_{y2}O_{b2}, the precursore can be expressed as AM1_{(1-y1})M1′_{y1}(OH)_{b1}-(1−A)M2_{(1-y2)}M2′_{y2}(OH)_{b2} or AM2_{(1-y1)}M1′_{y1}(CO₃)_{b1/2}-(1−A)M2_{(1-y2)}M2′_{y2}(CO₃)_{b2/2}, where A, a1, a2, b1, b2, y1, y2, the same meanings as the above.

In following method, metal salt solution I consisting of M1 and M1′ salts, and metal salt solution II consisting of M2 and M2′ salts;

The method of preparation of the precursor for the above cathode material can be any one of following two:

Method 1: Within time t₁ add a portion of metal salt solution I into alkaline solution or alkaline carbonate solution with pre-determined pH value and temperature T, while alkaline solution or alkaline carbonate solution is also added to keep the pH value of the system. The reaction time is t₁ₘ. Within time t₂ add a portion of metal salt solution II into alkaline solution or alkaline carbonate solution with pre-determined pH value and temperature T, while alkaline solution or alkaline carbonate solution is also added to keep the pH value of the system. The reaction time is t₂ₘ. Repeat these procedures till all salt solution is completely added into the system. Then allow it to react for time tₑ, followed by ripening for time tₛ. The reactant is filtered, dried. The precursor AM1_{(1-y1)}M1′_{y1l (OH)}_{b1}-(1−A)M2_{(1-y2)}M2′_{y2}(OH)_{b2} or AM1_{(1-y1)}M1′_{y1}(CO₃)_{b1/2}-(1−A)M2_{(1-y2)}M2′_{y2}(CO₃)_{b2/2} is obtained. The better concentration of the above alkaline solution or alkaline carbonate solution is 1-6M. It is the best that the portion of metal salt solution I added at each time is in the range of 10-50% volume of the total metal solution I, and the portion of metal salt solution II added at each time is in the range of 10-50% volume of the total metal solution II. The better concentration of metal salt solution I or II is 0.5-4M;

Method 2: Add metal salt solution I and metal salt solution II into alkaline solution or alkaline carbonate solution with pre-determined pH value and temperature T respectively, while add alkaline solution or alkaline carbonate solution to both systems to keep the pH value. Two reactant solutions Ir and Ilr are obtained. After allowing solution Ir to react for time tₘ and solution Ilr to react for tₘ′, mix them together to have a mixture. The mixture reacts for time tₑ with the pH value and temperature T, followed by ripening for time tₛ. The mixture is filtered and then dried. The precursor AM1_{(1-y1})M1′_{y1}(OH)_{b1}-(1−A)M2_{(1-y2})M2′_{y2}(OH)_{b2} or AM1_{(1-y1)}M1′yl (CO₃)_{b1/2}-(1−A)M2_{(1-y2)M}2′_{y2}(CO₃)_{b2/2} is obtained. The better concentration of metal salt solution I or II is 0.5-4M, and the better concentration of the above alkaline solution or alkaline carbonate solution is 1-6M.

It is better all the above mentioned reactions are carried out under stirring, and better under nitrogen atmosphere. (t₁+t₁ₘ), (t₂+t₂ₘ), tₘ and tₘ′ generally are not over 480 minutes, better not over 240 minutes, further better not over 30 minutes. Time tₑ is 1-8 hours, better 2-6 hours; tₛ is 6-48 hours, better 12-36 hours. The pH value is 9-12, better 11-12. Temperature is 25-70° C., better 45-55° C. 0<1−A/A<200, better, 0.25≦1−A/A≦4. The salt solutions can be transition metal salt solution in any forms, better is sulfonates, nitrates and oxalates that can easily dissolve in water and form stable salt solutions. The alkaline solutions can be any inorganic bases that contain hydroxide anions and can take place precipitating reactions the metal solutions, and the alkali hydroxide solutions are better. The alkaline carbonate solutions is better to be alkali carbonate or alkali hydrogen carbonate solutions, such as sodium carbonate solution, sodium hydrogen carbonate solution, potassium carbonate solution, potassium hydrogen carbonate solution .

The inventor found out, based on the reaction mechanism (Klaus Borho, Chemical Engineering Science, 2002, 57: 4257-4266), crystallization and agglomeration of spherical nickel hydroxide granule usually take following steps: reaction, nucleation, reversible aggregation, irreversible aggregation, growth and ripening. The reaction and nucleation processes take place as soon as the metal salt solution interacts with the alkaline solution (within micro second scale). The reversible aggregation and irreversible aggregation processes take place within a few seconds. During these processes the crystal nucleus formed in the nucleation process form crystal clusters, and these crystal clusters further aggregate and reorganize. The growth process takes place within a few minutes to a few hours. In this process, the crystal clusters reorganize and agglomerate to form primary particles, and at the same time, these primary particles reorganize, agglomerate and grow to form secondary particles. The ripening process takes more time, more than 10 hours, to complete. In this process, the secondary particles are gotten stabilized. If mixing the reactant (Ir) and (IIr) immediately after formation by reactions between metal salt solution (I) and (II) and alkaline solution, since the reactions are not completed, it is possible molecular level mixing between (Ir) and (IIr) to happen, which will lead to formation of a homogenous component. In this case, the precursor with pre-determined composite structures cannot be successfully produced. If mixing (Ir) and (IIr) in the reversible aggregation and irreversible aggregation processes, their crystal clusters can reorganize and agglomerate together and enter the growth process together, which is favorable to form composite structures within primary particles. If mixing (Ir) and (IIr) in the growth process, the agglomerates formed by crystal cluster reorganization and agglomeration reorganize and grow together to form primary particles. These primary particles and those primary particles already formed before mixing agglomerate grow together to form secondary particles, and then enter ripening process. If mixing (Ir) and (IIr) after the growth process, since many their own individual secondary particles have already formed, the composite structures formed in this process are not ideal. Therefore, it is the best that the procedure of mixing the reactants that are generated by reactions between the metal salt solution (I) and (II) and alkaline solutions takes place in the reversible aggregation, irreversible aggregation and growth processes. Thus, (t₁+t₁ₘ), (t₂+t₂ₘ) and tₘ are not over the time for growth completion, usually not over 480 minutes, best not over 30 minutes.

The current invention further involves methods of preparation of cathode materials for secondary lithium batteries. It includes following procedures:

(1) Prepare precursor; the method and conditions have been described in the above;

(2) Mix the precursor made in procedure (1) with lithium element containing compounds, followed by sintering the mixture. Then the above cathode material is obtained.

The lithium element containing compounds mentioned in the above are usually lithium hydroxide or lithium salts. The better lithium salts are lithium carbonate or lithium nitrate. The molar ratio of lithium ions in lithium hydroxide or lithium salts and the total transition metal ions in the precursor is better within 0.5 to 1.5, and further better within 0.95 to 1.1.

In the current invention, if small amount of lithium salts or ammonium salts containing X element is introduced during mixing the precursor and lithium element containing compounds, such as LiF or Li₃PO₄, the cathode material containing at least one component of [LiₐM_{(1-y)}M′_{y}O_{b}X_{c}]ₙ can be produced, where all symbols have the same meanings as described previously, but c does not equal to 0.

Meanwhile, the better method for the above procedure (2) is as follows: mixing the precursor produced in procedure (1) with lithium hydroxide or lithium salts homogenously, followed by sintering for time t_{c} at temperature T_{c} under oxygen containing atmosphere. After cooling and milling, the target cathode material is produced. The better atmosphere is oxygen, the better sintering temperature T_{c} is 600-950° C., further better 700-850° C.; the better sintering time t_{c} is 6-48 hours, further better 8-20 hours.

The cathode materials in the current invention can be used in secondary lithium batteries with excellent comprehensive properties. Thus, the current invention further includes secondary lithium batteries containing the cathode materials for secondary lithium batteries described in the invention.

In the current invention, the description of “more than . . . ” includes the two ending points, such as “more than two” includes two.

Except special notification, all raw materials and reagents involved in the current invention are available in commercial market.

The positive effects of the invention are:

(1) The invented cathode materials for secondary lithium batteries are different from the materials that are consisting of physical mixed secondary particles of different compositions. In the current invention, the mixing of different components takes place in a nanometer level within primary particles and/or between primary particles, which increases the effectiveness remarkable, and thus improves properties significantly.

(2) The invented cathode materials for secondary lithium batteries and molecular level active-inactive composite structures have fundamental differences. The reported molecular level active-inactive composite structures are made of homogenously mixed precursors, which produce micro phase separation structures during sintering due to the difference between molecular interaction forces. The composite structures in the current invention are realized through pre-formed composite structures between crystal clusters within primary particles and/or between primary particles in a nanometer level, which has less strict demands to structural matching than the molecular level active-inactive composite structures. Thus the current invention has a broader application areas, and better effectiveness.

(3) The invented cathode materials having composite structures of different components in a nanometer level can keep advantages of different materials, while compensating disadvantages, which can achieve better combined effects. The cathode materials with optimized components can achieve effects of high energy density, high power density, higher thermal stability and safety, high cyclability and lower cost.

### BRIEF DESCRIPTION OF THE DRAWINGS

FIG. 1: XRD spectra of precursors in Example 1-3 and Comparative Example 1-4.

FIG. 2A: Morphology of precursor S-1Q in Example 1 taken by scanning electronic spectroscope

FIG. 2B: Morphology of cathode material S-1 prepared in Example 1 taken by scanning electronic spectroscope

FIG. 3: XRD spectra of cathode materials prepared in Examples

FIG. 4: Charge/discharge curves of cathode materials prepared in Example 1-3 and Comparative Example 1-3 at 0.1 C rate measured in coin cells

FIG. 5A: Charge/discharge curves of cathode materials prepared in Example 1-2 and Comparative Example 1-3 at 1 C rate measured in prismatic cells

FIG. 5B: Charge/discharge curves of cathode materials prepared in Example 1-2 and Comparative Example 1-3 at 5 C rate measured in prismatic cells

FIG. 6: FIG. 5A: Cycling curves of cathode materials prepared in Example 1-2 and Comparative Example 1-2 measured in prismatic cells

FIG. 7: Correlation curves of self heating rate and temperature for cathode materials prepared in Example 1, Comparative Example 1 and 3 measured in prismatic cells

FIG. 8: Illustrative drawing of composites of different components between crystal clusters within primary particles and/or between primary particles in a nanometer level

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

Below examples are used to further describe the invention. The invention is not limited by these examples.

### COMPARATIVE EXAMPLE 1

### Preparation of Cathode Materials C-1, C-1A and C-1B, and Precursor C-1AQ

Dissolved nickel sulfonate and manganese sulfonate in water with a molar ratio of 5:5 to get homogenous 1M nickel manganese sulfonate solution. Under fast stirring, added the sulfonate solution together with 5M NaOH and 10M ammonia solution into alkaline solution containing NaOH/ammonia with pH=11-12. The system pH value was kept at 11-12 and temperature was kept at 45-55° C. The sulfonate solution had been added for 6 hours. Then the system had be kept stirring for another 6 hours. The reaction was carried out under nitrogen atmosphere. The reactant was allowed to store in stationary for 36 hours at room temperature. The reactant was then washed using water till pH value reached 7. It was filtered, and the solid was heat dried at 80° C. for 72 hours. The precursor, C-1AQ: Ni_{0.5}Mn_{0.5}(OH)₂, was thus derived.

C-1AQ precursor and lithium carbonate (Li₂CO₃) were mixed homogeneously with a 1.05 ratio of lithium ion moles and total transition metal moles in the precursor. The mixture was sintered in air. The temperature was first increased to 680° C. with a heating rate of 5° C./min, and kept at this temperature for 6 hours, followed increased to 850-980° C. with a heating rate of 2° C./min, and kept at this temperature for 15 hours. Then it was cooled down to room temperature naturally. The sintered product was milled and sieved by 300 mesh sieve. The cathode material, C1-A: LiNi_{0.5}Mn_{0.5}O₂, was thus derived.

A commercial precursor C-1 BQ: Ni_{0.8}Co_{0.1}Mn_{0.1}(OH)₂ (Yuyao Sanheng Electric Power Co. Ltd.) and lithium mono hydroxide (LiOH—H₂O) were mixed homogeneously with a 1.05 ratio of lithium ion moles and total transition metal moles in the precursor. The mixture was sintered in oxygen containing atmosphere. The temperature was first increased to 450-470° C. with a heating rate of 5° C./min, and kept at this temperature for 6 hours, followed increased to 700-800° C. with a heating rate of 2° C./min, and kept at this temperature for 15 hours. Then it was cooled down to room temperature naturally. The sintered product was milled and sieved by 300 mesh sieve. The cathode material, Cl-B: LiNi_{0.8}Co_{0.1}Mn_{0.1}O₂, was thus derived.

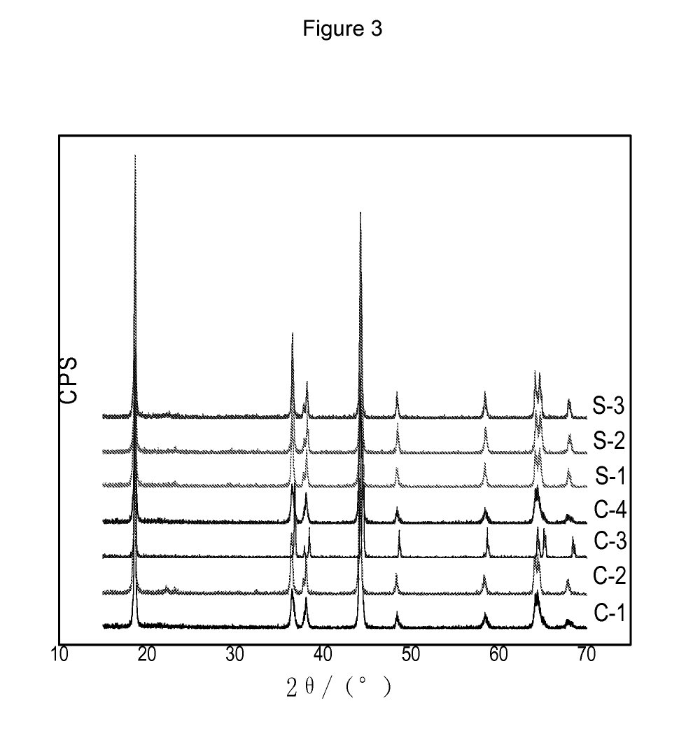

The C-1A and C-1 B were mixed with equal ratio by ball milling under dry air for 60 minutes. The cathode material C-1: 0.5 LiNi_{0.8}Co_{0.21}Mn_{0.1}O₂+0.5 LiNi_{0.5}Mn_{0.5}O₂, was thus derived. Its XRD spectrum was shown in FIG. 3. The splits between the diffraction peaks of (006) and (012) plane (274 ≈38°), and between the diffraction peaks of (018) and (110) plane (2θ≈65°) were not clear, indicating low structural regularity.

### COMPARATIVE EXAMPLE 2

### Preparation of Cathode Materials C-2 and Precursor C-2Q

Dissolved nickel sulfonate , cobalt sulfonate and manganese sulfonate in water with a molar ration of 6.5:0.5:3 to get homogenous 1M nickel cobalt manganese sulfonate solution. Under fast stirring, added the sulfonate solution together with 5M NaOH and 10M ammonia solution into alkaline solution containing NaOH/ammonia with pH=11-12. The system pH value was kept at 11-12 and temperature was kept at 45-55° C. The sulfonate solution had been added for 6 hours. Then the system had be kept stirring for another 6 hours. The reaction was carried out under nitrogen atmosphere. The reactant was allowed to store in stationary for 36 hours at room temperature. The reactant was then washed using water till pH value reached 7. It was filtered, and the solid was heat dried at 80° C. for 72 hours. The precursor, C-2Q: Ni_{0.65}Co_{0.05}Mn_{0.3}(OH)₂, was thus derived.

The precursor C-2Q and lithium mono hydroxide (LiOH—H₂O) were mixed homogeneously with a 1.05 ratio of lithium ion moles and total transition metal moles in the precursor. The mixture was sintered in oxygen containing atmosphere.

The temperature was first increased to 450-470° C. with a heating rate of 5° C./min, and kept at this temperature for 6 hours, followed increased to 750-850° C. with a heating rate of 2° C./min, and kept at this temperature for 15 hours. Then it was cooled down to room temperature naturally. The sintered product was milled and sieved by 300 mesh sieve. The cathode material, C-2: LiNi_{0.65}Co_{0.05}Mn_{0.3}O₂, was thus derived. Its XRD spectrum showed a typical layered structure (in FIG. 3). The splits between the diffraction peaks of (006) and (012) plane (2θ≈38°), and between the diffraction peaks of (018) and (110) plane (2θ≈65°) were not clear, indicating poor structural regularity.

### COMPARATIVE EXAMPLE 3

### Preparation of Cathode Materials C-3

A commercial precursor C-3Q: Ni_{0.33}Co_{0.33}M_{0.33}(OH)₂ (Yuyao Sanheng Electric Power Co. Ltd.) and lithium carbonate (Li₂CO₃) were mixed homogeneously with a 1.05 ratio of lithium ion moles and total transition metal moles in the precursor. The mixture was sintered in air. The temperature was first increased to 650-680° C. with a heating rate of 5° C./min, and kept at this temperature for 6 hours, followed increased to 850-950° C. with a heating rate of 2° C./min, and kept at this temperature for 15 hours. Then it was cooled down to room temperature naturally. The sintered product was milled and sieved by 300 mesh sieve. The cathode material, C-3: LiNi_{0.33}Co_{0.33}Mn_{0.33}O₂, was thus derived. Its XRD spectrum showed a typical layered structure (FIG. 3).

### COMPARATIVE EXAMPLE 4

### Preparation of Cathode Materials C-4

The precursor C-1AQ in Comparative Example 1 and commercial precursor C-1 BQ: Ni_{0.8}Co_{0.1}Mn_{0.1}(OH)₂ (Yuyao Sanheng Electric Power Co. Ltd.) were homogenously mixed with an 1:1 ratio. Then, the mixture and lithium mono hydroxide (LiOH—H₂O) were mixed homogeneously with a 1.05 ratio of lithium ion moles and total transition metal moles in the precursor. The mixture was sintered in oxygen containing atmosphere. The temperature was first increased to 450-470° C. with a heating rate of 5° C./min, and kept at this temperature for 6 hours, followed increased to 700-850° C. with a heating rate of 2° C./min, and kept at this temperature for 15 hours. Then it was cooled down to room temperature naturally. The sintered product was milled and sieved by 300 mesh sieve. The cathode material, C-4: 0.5 LiNi_{0.5}Co_{0.1}Mn_{0.1}O₂+0.5 LiNi_{0.5}Mn_{0.5}O₂, was thus derived. There was no splits between the diffraction peaks of (006) and (012) plane (2θ≈38°), and between the diffraction peaks of (018) and (110) plane (2θ≈65°) observed in its XRD spectrum (FIG. 3), indicating very poor structural regularity.

### EXAMPLE 1

### Preparation of Cathode Material S-1 and its Precursor S-1Q

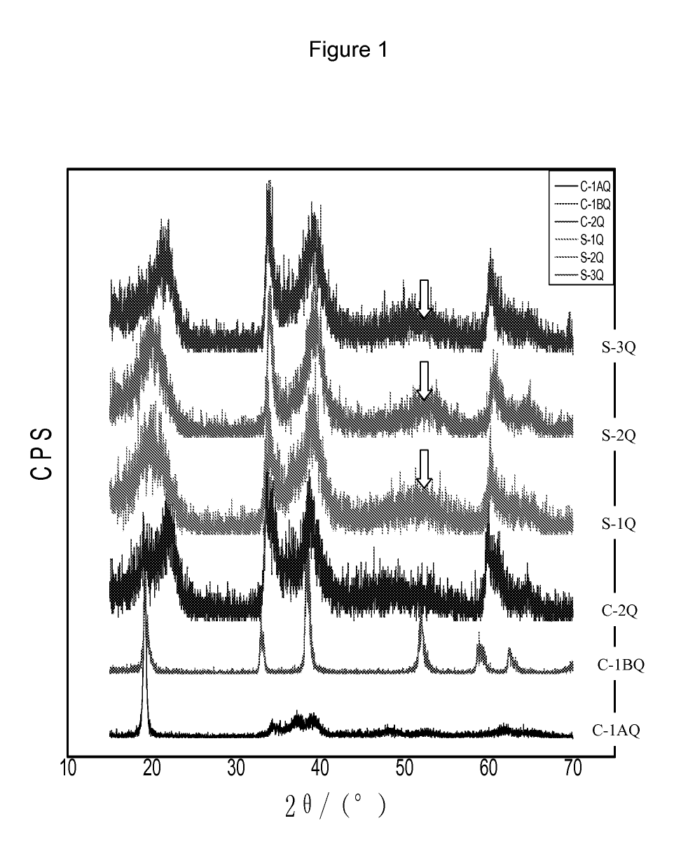

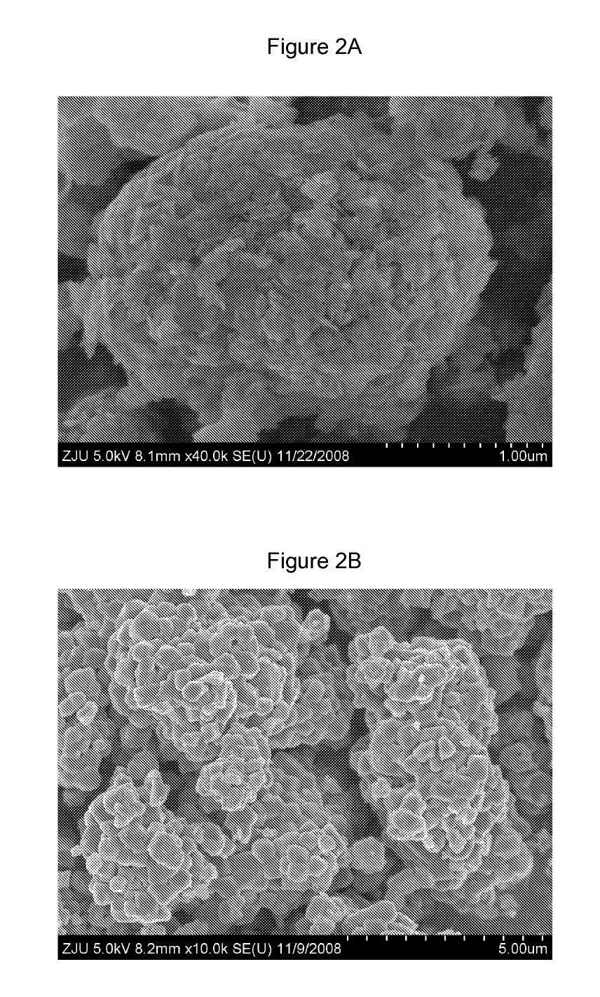

Dissolved nickel sulfonate , cobalt sulfonate and manganese sulfonate in water with a molar ration of 8:1:1 to get homogenous 4 liters 1M nickel cobalt manganese sulfonate solution (I). Dissolved nickel sulfonate and manganese sulfonate in water with a molar ration of 5:5 to get homogenous 4 liters 1M nickel manganese sulfonate solution (II). Under fast stirring, added 2 liters the solution (I) with a flow rate of 17 ml/minute together with 5M NaOH and 10M ammonia solution into alkaline solution containing NaOH and ammonia solution with pH=11-12. The system temperature was kept at 45-55° C. and pH value was kept at 11-12. After adding the solution (I) for 120 minutes, stopped adding solution and stirred for 10 minutes. Under fast stirring, added 2 liters the solution (II) with a flow rate of 17 ml /minute together with 5M NaOH and 10M ammonia solution into alkaline solution containing NaOH and ammonia solution with pH=11-12. The system temperature was kept at 45-55° C. and pH value was kept at 11-12. After adding the solution (II) for 120 minutes, stopped adding solution and stirred for 10 minutes. The above procedures were repeated one more time, and the total transition metal moles in added solution (I) were allowed to equal to the total transition metal moles in added solution (II). After finishing adding all salt solutions, the reactants were stirred for 6 hours. All above reactions were carried out in nitrogen atmosphere. The reactant was allowed to store in stationary for 36 hours at room temperature. The reactant was then washed using water till pH value reached 7. It was filtered, and the solid was heat dried at 80° C. for 72 hours. The precursor, S-1Q: 0.5Ni_{0.8}Co_{0.1}Mn_{0.1}(OH)₂-0.5Ni_{0.5}Mn_{0.5}(OH)₂was thus derived. The average composition of the precursor determined by atomic absorption spectrometer (AAS) was: Ni_{0.652}Co_{0.058}Mn_{0.290}(OH)₂. Using X-ray diffraction spectrometer (XRD) to analyze the commercial precursor Ni_{0.8}Co_{0.1}Mn_{0.1}(OH)₂, Ni_{0.5}Mn_{0.5}(OH)₂, and precursor S-1Q (FIG. 1), a diffractin peak appeared at around 2θ≈52° in S-1Q, which only appeared in Ni_{0.8}Co_{0.1}Mn_{0.1}(OH)₂. This indicated that the precursor S-1Q already had the pre-determined composite structures. The SEM measurement showed that precursor S-1 Q had a near spherical morphology (FIG. 2A).

The precursor S-1Q and lithium mono hydroxide (LiOH-H₂O) were mixed homogeneously with a 1.05 ratio of lithium ion moles and total transition metal moles in the precursor. The mixture was sintered in oxygen containing atmosphere. The temperature was first increased to 450-470° C. with a heating rate of 5° C./min, and kept at this temperature for 4 hours, followed increased to 750-850° C. with a heating rate of 2° C./min, and kept at this temperature for 15 hours. Then it was cooled down to room temperature naturally. The sintered product was milled and sieved by 300 mesh sieve. The cathode material S-1, 0.5LiNi_{0.8}Co_{0.1}Mn_{0.1}O₂-0.5LiNi_{0.5}Mn_{0.5}O₂ was thus derived. The average composition of S-1 determined by atomic absorption spectrometer (AAS) was: Li_{1.02}Ni_{0.645}Co_{0.06}Mn_{0.295}O₂. Its XRD pattern had typical layered structure (FIG. 3). And it had a near spherical morphology (FIG. 2B). The split between the diffraction peaks of (006) and (012) plane (2θ≈38°) was clear, and the split between the diffraction peaks of (018) and (110) plane (2θ≈65°) was also clear, indicating good structural regularity. But the above peak splits in Comparative Example C-1, C-2 and C-4 were not clear, indicating their poor structural regularity.

### EXAMPLE 2

### Preparation of Cathode Material S-2 and its Precursor S-2Q

Dissolved nickel sulfonate , cobalt sulfonate and manganese sulfonate in water with a molar ration of 8:1:1 to get homogenous 4 liters 1M nickel cobalt manganese sulfonate solution (I). Dissolved nickel sulfonate and manganese sulfonate in water with a molar ration of 5:5 to get homogenous 4 liters 1M nickel manganese sulfonate solution (II). Under fast stirring, added the solution (I) and (II) with the same flow rate (34 ml/minute) respectively together with 5M NaOH and 10M ammonia solution into alkaline solution containing NaOH and ammonia solution with pH=11-12. The system temperature was kept at 45-55° C. and pH value was kept at 11-12. After allowing the solution (I) and (II) to react with alkaline solution respectively for a short period of time (not over 30 minutes), the reactant of solution (I) and (II) were mixed. The total transition metal moles in added solution (I) were allowed to equal to the total transition metal moles in added solution (II). After finishing adding all salt solutions, the reactants were stirred for 6 hours. All above reactions were carried out in nitrogen atmosphere. The reactant was allowed to store in stationary for 36 hours at room temperature. The reactant was then washed using water till pH value reached 7. It was filtered, and the solid was heat dried at 80° C. for 72 hours. The precursor, S-2Q: 0.5Ni_{0.8}Co_{0.1}Mn_{0.1.}(OH)₂-0.5Ni_{0.5}Mn_{0.5}(OH)₂ was thus derived. The average composition of the precursor determined by atomic absorption spectrometer (AAS) was: Ni_{0.652}Co_{0.058}Mn_{0.290}(OH)₂. In its XRD spectrum a diffraction peak appeared at around 2θ52° (FIG. 1), indicating that the precursor S-2Q already had the pre-determined composite structures.

Precursor S-2Q and lithium carbonate (Li₂CO₃) were mixed homogeneously with a 1.05 ratio of lithium ion moles and total transition metal moles in the precursor. The mixture was sintered in air. The temperature was first increased to 650-680° C. with a heating rate of 5° C./min, and kept at this temperature for 6 hours, followed increased to 750-850° C. with a heating rate of 2° C./min, and kept at this temperature for 18 hours. Then it was cooled down to room temperature naturally. The sintered product was milled and sieved by 300 mesh sieve. The cathode material S-2, 0.5LiNi_{0.8}Co_{0.1}Mn_{0.1}O₂-0.5LiNi_{0.5}Mn_{0.5}O₂, was thus derived. The average composisiton of S-2 determined by atomic absorption spectrometer (AAS) was: Li_{1.02}Ni_{0.660}Co_{0.06}Mn_{0.280}O₂. Its XRD pattern had typical layered structure (FIG. 3). Similar to S-1, in its XRD the split between the diffraction peaks of (006) and (012) plane (2θ≈38°) was clear, and the split between the diffraction peaks of (018) and (110) plane (2θ65°) was also clear, indicating good structural regularity.

### EXAMPLE 3

### Preparation of Cathode Material S-3 and its Precursor S-3Q

Dissolved nickel sulfonate, cobalt sulfonate and manganese sulfonate in water with a molar ration of 8:1:1 to get homogenous 4 liters 1M nickel cobalt manganese sulfonate solution (I). Dissolved nickel sulfonate, magnesium sulfonate and manganese sulfonate in water with a molar ration of 4.5:0.5:5 to get homogenous 4 liters 1M nickel magnesium manganese sulfonate solution (II). Under fast stirring, added the solution (I) and (II) with the same flow rate (34 ml/minute) respectively together with 5M NaOH and 10M ammonia solution into alkaline solution containing NaOH and ammonia solution with pH=11-12. The system temperature was kept at 45-55° C. and pH value was kept at 11-12. After allowing the solution (I) and (II) to react with alkaline solution respectively for a short period of time (not over 30 minutes), the reactant of solution (I) and (II) were mixed. The total transition metal moles in added solution (I) were allowed to equal to the total transition metal moles in added solution (II). After finishing adding all salt solutions, the reactants were stirred for 6 hours. All above reactions were carried out in nitrogen atmosphere. The reactant was allowed to store in stationary for 36 hours at room temperature. The reactant was then washed using water till pH value reached 7. It was filtered, and the solid was heat dried at 80° C. for 72 hours. The precursor, S-3Q: 0.5Ni_{0.8}Co_{0.1}Mn_{0.1}(OH₂-0.5Ni_{0.45}Mg_{0.05}Mn_{0.5}(OH)₂was thus derived. The average composition of the precursor determined by atomic absorption spectrometer (AAS) was: Ni_{0.615}Mg_{0.25}Co_{0.56}Mn_{0.304}(OH)₂ . In its XRD spectrum a diffraction peak appeared at around 2θ≈52° (FIG. 1), indicating that the precursor S-3Q already had the pre-determined composite structures.

Precursor S-3Q and lithium carbonate (Li₂CO₃) were mixed homogeneously with a 1.05 ratio of lithium ion moles and total transition metal moles in the precursor. The mixture was sintered in air. The temperature was first increased to 650-680° C. with a heating rate of 5° C./min, and kept at this temperature for 6 hours, followed increased to 750-850° C. with a heating rate of 2° C./min, and kept at this temperature for 18 hours. Then it was cooled down to room temperature naturally. The sintered product was milled and sieved by 300 mesh sieve. The cathode material S-3, 0.5LiNi_{0.8}Co_{0.1}Mn_{0.1}O₂-0.5LiNi_{0.5}Mg_{0.05}Mn_{0.5}O₂, was thus derived. The average composition of S-2 determined by atomic absorption spectrometer (AAS) was: Li_{1.02}Ni_{0.613}Mg_{0.026}Co_{0.058}Mn_{0.303}O₂ . Its XRD pattern had typical layered structure (FIG. 3). Similar to S-1, in its XRD the split between the diffraction peaks of (006) and (012) plane (2θ≈38°) was clear, and the split between the diffraction peaks of (018) and (110) plane (2θ≈65°) was also clear, indicating good structural regularity.

### EXAMPLE 4

### Preparation of Cathode Material S-4

The precursor S-1Q and lithium mono hydroxide (LiOH-H₂O) and lithium fluoride were mixed homogeneously in a proportion of: [LiF]([LiOH-H₂O]+[LiF])=0.01, and a 1.05 ratio of lithium ion moles and total transition metal moles in the precursor. The mixture was sintered in oxygen containing atmosphere. The temperature was first increased to 450-470° C. with a heating rate of 5° C./min, and kept at this temperature for 4 hours, followed increased to 750-850° C. with a heating rate of 2° C./min, and kept at this temperature for 15 hours. Then it was cooled down to room temperature naturally. The sintered product was milled and sieved by 300 mesh sieve. The cathode material S-4, 0.5LiNi_{0.8}Co_{0.1}Mn_{0.1}O_{1.99}F_{0.01}-0.5LiNi_{0.5}Mn_{0.5}O_{1.99}F_{0.01}, was thus derived. The average composition of S-1 determined by atomic absorption spectrometer (AAS) was: Li_{1.02}Ni_{0.655}Co_{0.05}Mn_{0.295}O_{1.99}F_{0.01}.

### EXAMPLE 5

### Preparation of Cathode Material S-1 and its Precursor S-1Q

Dissolved nickel nitrate , cobalt nitrate and manganese nitrate in water with a molar ration of 8:1:1 to get homogenous 3 liters 1M nickel cobalt manganese nitrate solution (I). Dissolved nickel nitrate and manganese nitrate in water with a molar ration of 5:5 to get homogenous 3 liters 1M nickel manganese nitrate solution (II). Under fast stirring, added 1 liter the solution (I) with a flow rate of 5 ml/minute together with 5M NaOH and 10M ammonia solution into alkaline solution containing NaOH and ammonia solution with pH=9-11. The system temperature was kept at 25-40° C. and pH value was kept at 9-11. After adding the solution (I) for 200 minutes, stopped adding solution and stirred for 40 minutes. Under fast stirring, added 1 liter the solution (II) with a flow rate of 5 ml/minute together with 5M NaOH and 10M ammonia solution into alkaline solution containing NaOH and ammonia solution. The system temperature was kept at 25-40° C. and pH value was kept at 11-12. After adding the solution (II) for 200 minutes, stopped adding solution and stirred for 40 minutes. The above procedures were repeated two more times, and the total transition metal moles in added solution (I) were allowed to equal to the total transition metal moles in added solution (II). After finishing adding all salt solutions, the reactants were stirred for 8 hours. All above reactions were carried out in nitrogen atmosphere. The reactant was allowed to store in stationary for 48 hours at room temperature. The reactant was then washed using water till pH value reached 7. It was filtered, and the solid was heat dried at 80° C. for 72 hours. The precursor, S-1Q: 0.5Ni_{0.8}Co_{0.1}Mn_{0.1}(OH)₂-0.5Ni_{0.5}Mn_{0.5}(OH)₂ was thus derived. The average composition of the precursor determined by atomic absorption spectrometer (AAS) was: Ni_{0.652}Co_{0.058}Mn_{0.290}(OH)₂. Its XRD was the same as S-1Q in Example 1, indicating that they were the same precursors.

The precursor S-1Q and lithium mono hydroxide (LiOH-H₂O) were mixed homogeneously with a 1.05 ratio of lithium ion moles and total transition metal moles in the precursor. The mixture was sintered in oxygen containing atmosphere.

The temperature was first increased to 450-470° C. with a heating rate of 5° C./min, and kept at this temperature for 1 hour, followed increased to 600-800° C. with a heating rate of 2° C./min, and kept at this temperature for 6 hours. Then it was cooled down to room temperature naturally. The sintered product was milled and sieved by 300 mesh sieve. The cathode material S-1, 0.5LiNi_{0.8}CO_{0.1}Mn_{0.1}O₂-0.5LiNi_{0.5}Mn_{0.5}O₂, was thus derived. The average composition of S-1 determined by atomic absorption spectrometer (AAS) was: Li_{1.02}Ni_{0.645}Co_{0.06}Mn_{0.295}O₂. Its XRD was the same as S-1 in Example 1, indicating that they were the same cathode materials.

### EXAMPLE 6

### Preparation of Cathode Material S-1 and its Precursor S-1Q

Dissolved nickel sulfonate , cobalt sulfonate and manganese sulfonate in water with a molar ration of 8:1:1 to get homogenous 9 liters 1M nickel cobalt manganese sulfonate solution (I). Dissolved nickel sulfonate and manganese sulfonate in water with a molar ration of 5:5 to get homogenous 9 liters 1M nickel manganese sulfonate solution (II). Under fast stirring, added 4.5 liters the solution (I) with a flow rate of 10 ml/minute together with 5M NaOH and 10M ammonia solution into alkaline solution containing NaOH and ammonia solution with pH=11-12. The system temperature was kept at 55-65° C. and pH value was kept at 11-12. After adding the solution (I) for 450 minutes, stopped adding solution and stirred for 30 minutes. Under fast stirring, added 4.5 liters the solution (II) with a flow rate of 10 ml /minute together with 5M NaOH and 10M ammonia solution into alkaline solution containing NaOH and ammonia solution. The system temperature was kept at 65° C. and pH value was kept at 11-12. After adding the solution (II) for 450 minutes, stopped adding solution and stirred for 30 minutes. The above procedures were repeated one more time, and the total transition metal moles in added solution (I) were allowed to equal to the total transition metal moles in added solution (II). After finishing adding all salt solutions, the reactants were stirred for 2 hours. The reactant was allowed to store in stationary for 6 hours at room temperature. The reactant was then washed using water till pH value reached 7. It was filtered, and the solid was heat dried at 80° C. for 72 hours. The precursor, S-1Q: 0.5Ni_{0.8}Co_{0.1}Mn_{0.1}(OH)₂-0.5Ni_{0.5}Mn_{0.5}(OH)₂was thus derived. The average composition of the precursor determined by atomic absorption spectrometer (AAS) was: Ni_{0.652}Co_{0.058}Mn_{0.290}(OH)₂. Its XRD was the same as S-1 Q in Example 1, indicating that they were the same precursors.

The precursor S-1Q and lithium mono hydroxide (LiOH-H₂O) were mixed homogeneously with a 1.1 ratio of lithium ion moles and total transition metal moles in the precursor. The mixture was sintered in oxygen containing atmosphere. The temperature was first increased to 450-470° C. with a heating rate of 5° C./min, and kept at this temperature for 1 hours, followed increased to 600-900° C. with a heating rate of 2° C./min, and kept at this temperature for 48 hours. Then it was cooled down to room temperature naturally. The sintered product was milled and sieved by 300 mesh sieve. The cathode material S-1, 0.5LiNi_{0.8}CO_{0.1}Mn_{0.1}O₂-0.5LiNi_{0.5}Mn_{0.5}O₂, was thus derived. The average composition of S-1 determined by atomic absorption spectrometer (AAS) was: Li_{1.02}Ni_{0.645}Co_{0.06}Mn_{0.295}O₂. Its XRD was the same as S-1 in Example 1, indicating there were the same cathode materials.

### EXAMPLE 7

### Preparation of Cathode Material S-2 and its Precursor S-2Q

Dissolved nickel oxalate, cobalt oxalate and manganese oxalate in water with a molar ration of 8:1:1 to get homogenous 4 liters 1M nickel cobalt manganese oxalate solution (I). Dissolved nickel oxalate and manganese oxalate in water with a molar ration of 5:5 to get homogenous 4 liters 1M nickel manganese oxalate solution (II). Under fast stirring, added the solution (I) and (II) with the same flow rate (34 ml/minute) respectively together with 5M NaOH and 10M ammonia solution into alkaline solution containing NaOH and ammonia solution with pH=11-12. The system temperature was kept at 50-65° C. and pH value was kept at 11-12. After allowing the solution (I) and (II) to react with alkaline solution respectively for a short period of time (not over 30 minutes), the reactant of solution (I) and (II) were mixed. The total transition metal moles in added solution (I) were allowed to equal to the total transition metal moles in added solution (II). After finishing adding all salt solutions, the reactants were stirred for 1 hours. All above reactions were carried out in nitrogen atmosphere. The reactant was allowed to store in stationary for 12 hours at room temperature. The reactant was then washed using water till pH value reached 7. It was filtered, and the solid was heat dried at 80° C. for 72 hours. The precursor, S-2Q: 0.5Ni_{0.8}Co_{0.1}Mn_{0.1}(OH)₂-0.5Ni_{0.5}Mn_{0.5}(OH)₂ was thus derived. The average composition of the precursor determined by atomic absorption spectrometer (AAS) was: Ni_{0.652}Co_{0.058}Mn_{0.290}(OH)₂ . In its XRD was the same as S-2Q in Example 2, indicating that they were the same precursors.

Precursor S-2Q and lithium carbonate (Li₂CO₃) were mixed homogeneously with a 1.05 ratio of lithium ion moles and total transition metal moles in the precursor. The mixture was sintered in air. The temperature was first increased to 650-680° C. with a heating rate of 5° C./min, and kept at this temperature for 6 hours, followed increased to 750-850° C. with a heating rate of 2° C./min, and kept at this temperature for 18 hours. Then it was cooled down to room temperature naturally. The sintered product was milled and sieved by 300 mesh sieve. The cathode material S-2, 0.5LiNi_{0.8}Co_{0.1}Mn_{0.1}O₂-0.5LiNi_{0.6}Mn_{0.5}O₂, was thus derived. The average composition of S-2 determined by atomic absorption spectrometer (AAS) was: Li_{1.02}Ni_{0.660}Co_{0.06}Mn_{0.280}O₂. Its XRD was the same as S-2 in Example 2, indicating the they were the same cathode materials.

Implementing Effect Example 1 Measurement of Properties of Cathode Material S-1

1.1 Measurement of Electrochemical Properties

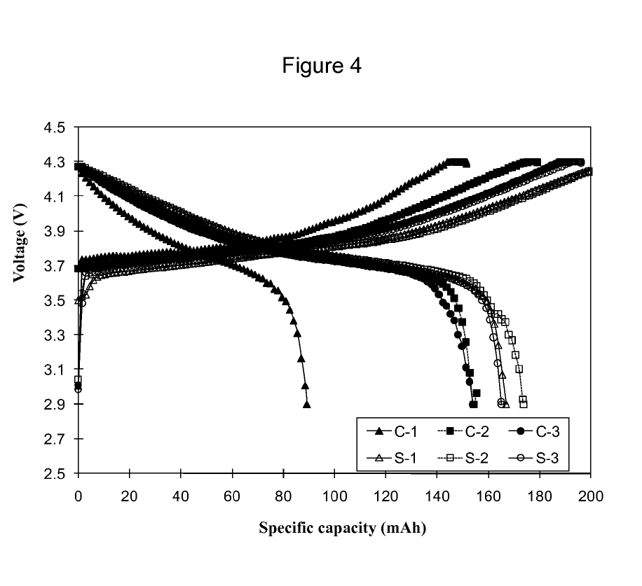

94 weight parts of S-1, 3 weight parts of conducting reagent acetylene carbon black SuperP, 3 weight parts of adhesive reagent PVDF were added into 50 weight parts of N-methyl-2-pyrrolidone (NMP) solvent under stirring to form slurry. The slurry was coated on a 15 micron thick aluminum foil. After drying at 150° C. for 30 minutes to remove the solvent, followed by pressing the coated foil by a calendar roll, electrodes with a diameter of 1.6 centimeter were made. The coating thickness of the electrode was approximately 60 micrometers, and the coating weight was approximately 30 mini grams. The coin cell size was CR2016. The anode was a lithium foil with a diameter of 1.6 centimeters. The separator was a 150 micron thick porous glass fiber with a diameter of 1.8 cm. The electrolyte was EC/DMC/EMC-LiPF₆ 1M. The coin cell was charged to 4.30V with a constant current of 15 mA/g (0.1C) at ambient temperature (22° C.), followed by constant voltage charging at 4.30V with charging termination when the current reached 3 mA/g. After resting 10 minutes, it was discharged with a constant current of 15 mA/g (0.1C) to 2.90V. The 1^{st} cycle charging and discharging curves of coin cells were shown in FIG. 4. The measured specific capacity of cathode material S-1 was 168 mAh/g, and the 1^{st} cycle columbic efficiency was 88%, which are significantly higher than Comparative Example s (Table 1).

1.2 Fabrication and Measurement of Prismatic cells (L×W×T=50×30×5.2 mm)

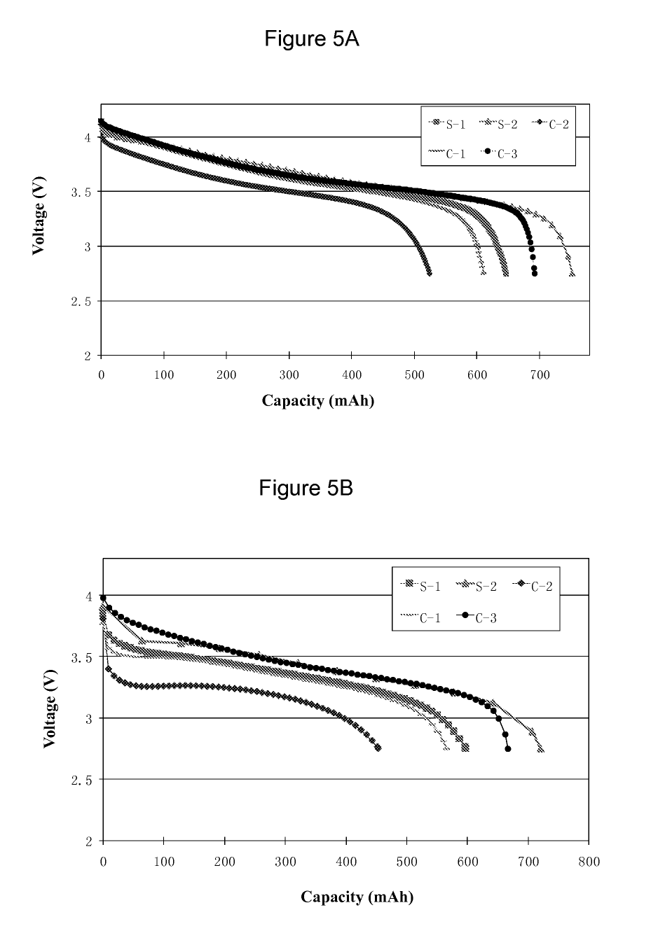

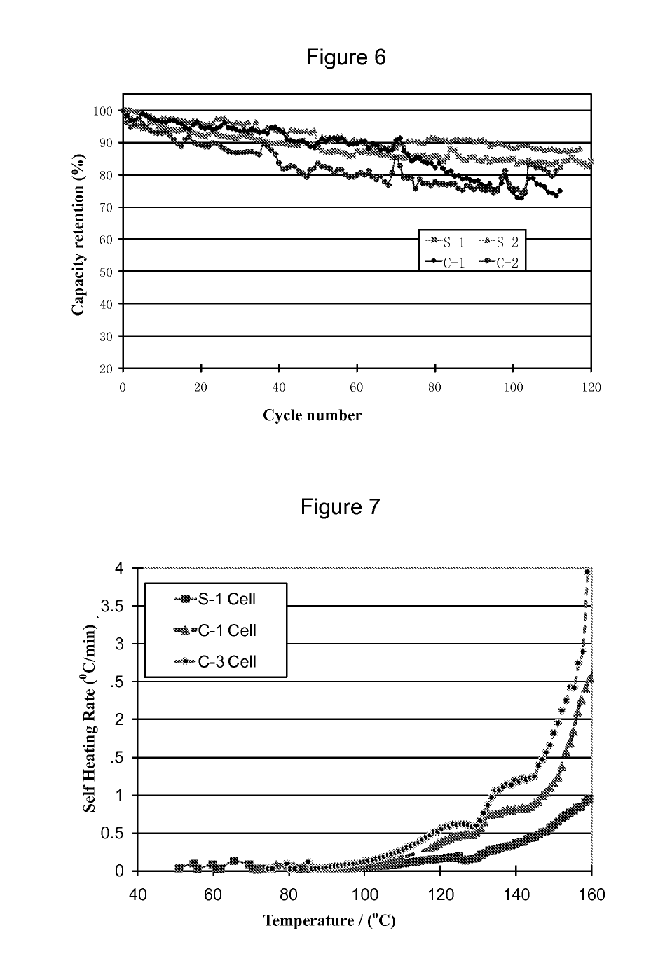

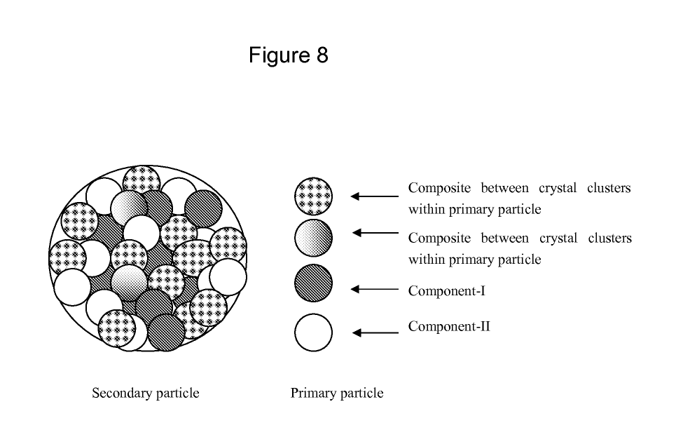

86 weight parts of S-1, 7 weight parts of conducting reagent acetylene carbon black SuperP, 7 weight parts of adhesive reagent PVDF were added into 55 weight parts of N-methyl-2-pyrrolidone (NMP) solvent under stirring to form slurry. The slurry was double-side coated on a 15 micron thick aluminum foil by a blade in a coater. After drying at 150° C. to remove the solvent in an oven, followed by pressing the foil using a calendar roll, electrodes with a length of 54 cm and width of 4.2 cm were made. The coating thickness of the electrode was approximately 120 micrometers, and the press density of the composite electrode was 2.7 g/cc. The separator was a polyethylene with a thickness of 20 micrometers, the electrolyte was EC/DMC/EMC-LiPF₆ 1M, and the anode was a modified natural graphite (BTR 818-MB). The designed capacity of the cell was 700 mAh. The cell after processes of drying, electrolyte injection, aging, formation and sealing was charged with a 700 mA (1 C) current to 4.2V at ambient temperature (22° C.), followed by constant voltage charging at 4.2V with charging termination when the current reached 35 mA. The specific capacity of S-1 cathode material was 142 mAh/g measured at 1 C discharging rate. At 5 C current discharging rate, the delivered capacity at 5 C/the delivered capacity at 1 C=93%. The charging and discharging curves were shown in FIGS. 5A and 5B. The cycling curves of cells with cycling at 1 C charging and discharging rate were in FIG. 6. All these properties are significantly improved in comparison to Comparative Example 1, 2 and 4 (Table 2).

1.3 Measurement of Thermal Stability and Safety of Cells

Accelerating Rate calorimetry (ARC) is a better technique for analysis of the thermal stability of a material and system (Maleki et al., J. Electrochem. Soc., 146, 3224 (1999)). By measuring exothermic reactions of a system precisely under adiabatic conditions, including generated heat, heat generating rate, the temperature and time for the system thermal runaway and exothermic reaction rate and mechanisms can be derived.

The prismatic cell made of S-1 cathode material at a 4.2V fully charged state was loaded in an ARC (Thermal Hazard Technology). It was heated with a rate of 3° C./min from a starting point of 30° C. The waiting time was set to be 15 min. The self-heating rate curves measured were shown in FIG. 7. The cell made of S-1 cathode material had a much lower self-heat rate than Comparative Examples, indicating it had higher thermal stability and safety than Comparative Examples.

Implementing Effect Example 2 Measurement of Properties of Cathode Material S-2

Coin cells and prismatic cells made of cathode material S-2 in Example 2 were fabricated measured using the same methods and conditions as in Implementing Effect Example 1. The specific capacity of cathode material S-2 was 170 mAh/g measured by coin cells at 0.1 C (15 mA/g) charging and discharging rate (charging and discharging range of 2.90-4.30V), and 1^{st} cycle columbic efficiency was 88%, which are significantly higher than Comparative Example s (FIG. 4 and Table 1). The specific capacity of cathode material S-2 was 157 mAh/g measured in prismatic cells at 1 C (700 mA) charging and discharging rate (charging and discharging range of 2.75-4.20V). At 5 C current discharging rate, the delivered capacity at 5 C/the delivered capacity at 1 C=96%, which is significantly higher than Comparative Example s (Table 2). The charging and discharging curves were shown in FIGS. 5A and 5B.

Implementing Effect Example 3 Measurement of Properties of Cathode Material S-3

Coin cells made of cathode material S-3 in Example 3 were fabricated measured using the same methods and conditions as in Implementing Effect Example 1. The specific capacity of cathode material S-3 was 166 mAh/g measured by coin cells at 0.1 C (15 mA/g, charging and discharging range of 2.90-4.30V), and 1^{st} cycle columbic efficiency was 85%, which are significantly higher than Comparative Example s (FIG. 4 and Table 1).

Implementing Effect Example 4 Measurement of Property of Cathode Material S-4

Coin cells made of made of cathode material S-4 were fabricated measured using the same methods and conditions as in Implementing Effect Example 1. The specific capacity of cathode material S-3 was 164 mAh/g measured by coin cells at 0.1 C (15 mA/g, charging and discharging range of 2.90-4.30 V), and 1^{st} cycle columbic efficiency was 85%, which are significantly higher than Comparative Example s (FIG. 4 and Table 1).

Implementing Effect Example 5 Measurement of Properties of Cathode Material C-1, C-2, C-3 and C-4

Coin cells and prismatic cells made of cathode material C-1 in Comparative Example 1 were fabricated measured using the same methods and conditions as in Implementing Effect Example 1. The specific capacity of cathode material C-1 was 155 mAh/g measured by coin cells at 0.1 C (15 mA/g) charging and discharging rate (charging and discharging range of 2.90-4.30V), and 1^{st} cycle columbic efficiency was 85% (FIG. 4 and Table 1). The specific capacity of cathode material C-1 was 135 mAh/g measured in prismatic cells at 1 C (700 mA) charging and discharging rate (charging and discharging range of 2.75-4.20V). At 5 C current discharging rate, the delivered capacity at 5 C/the delivered capacity at 1 C=92% (Table 2). The charging and discharging curves were shown in FIGS. 5A and 5B, and the cycling curve was shown in FIG. 6.

The prismatic cell made of C-1 cathode material at a 4.2V fully charged state was loaded in an ARC. It was heated with a rate of 3° C./min from a starting point of 30° C. The waiting time was set to be 15 min. The self-heating rate curves measured were shown in FIG. 7.

Coin cells and prismatic cells made of cathode material C-2 in Comparative Example 2 were fabricated measured using the same methods and conditions as in Implementing Effect Example 1. The specific capacity of cathode material C-2 was 155 mAh/g measured by coin cells at 0.1 C (15 mA/g) charging and discharging rate (charging and discharging range of 2.90-4.30V), and 1^{st} cycle columbic efficiency was 87% (FIG. 4 and Table 1). The specific capacity of cathode material C-1 was 108 mAh/g measured in prismatic cells at 1 C (700 mA) charging and discharging rate (charging and discharging range of 2.75-4.20V). At 5 C current discharging rate, the delivered capacity at 5 C/the delivered capacity at 1 C=86% (Table 2). The charging and discharging curves were shown in FIGS. 5A and 5B, and the cycling curve was shown in FIG. 6.

Coin cells and prismatic cells made of cathode material C-3 in Comparative Example 3 were fabricated measured using the same methods and conditions as in Implementing Effect Example 1. The specific capacity of cathode material C-3 was 161 mAh/g measured by coin cells at 0.1 C (15 mA/g) charging and discharging rate (charging and discharging range of 2.90-4.30V), and 1^{st} cycle columbic efficiency was 87% (FIG. 4 and Table 1). The specific capacity of cathode material C-3 was 146 mAh/g measured in prismatic cells at 1 C (700 mA) charging and discharging rate (charging and discharging range of 2.75-4.20V). At 5 C current discharging rate, the delivered capacity at 5 C/the delivered capacity at 1 C=96% (Table 2). The charging and discharging curves were shown in FIGS. 5A and 5B.

The prismatic cell made of C-3 cathode material at a 4.2V fully charged state was loaded in an ARC. It was heated with a rate of 3° C./min from a starting point of 30° C. The waiting time was set to be 15 min. The self-heating rate curves measured were shown in FIG. 7.

Coin cells made of cathode material C-4 in Comparative Example 4 were fabricated measured using the same methods and conditions as in Implementing Effect Example 1. The specific capacity of cathode material C-4 was 88 mAh/g measured by coin cells at 0.1 C (15 mA/g, charging and discharging range of 2.90-4.30V), and 1^{st} cycle columbic efficiency was 57% (Table 1).

TABLE 1
Results measured by coin cells

| | Specific capacity | 1^{st} cycle columbic |
|---|---|---|
| Sample | at 0.1 C (mAh/g) | efficiency (%) |
| S-1 | 168 | 88 |
| S-2 | 172 | 88 |
| S-3 | 166 | 85 |
| C-1 | 155 | 85 |
| C-2 | 155 | 87 |
| C-3 | 161 | 87 |
| C-4 | 88 | 57 |

TABLE 2
Results measured by prismatic cells

| | Specific capacity | 5 C/1 C capacity |
|---|---|---|
| Sample | at 1 C (mAh/g) | ratio (%) |
| S-1 | 142 | 93 |
| S-2 | 157 | 96 |
| C-1 | 135 | 92 |
| C-2 | 108 | 86 |
| C-3 | 146 | 96 |

1. A cathode material for secondary lithium batteries, characterized in that:
being a composite structural material formed by compositing more than two different components selected from a general formula of [LiₐM_{1-y}M′_{y}O_{b}X_{c}]ₙ; said composite structures are formed between crystal clusters within primary particles and/or between primary particles; where M is any one of Ni, Co, Mn, Ti, V, Fe and Cr, M′ is any one of Mg, Al, Ca, Sr, Zr, Ni, Co, Mn, Ti, V, Fe, Cr, Zn, Cu, Si, Na and K or combinations of two or more than two of them; X is any one of F, S, N, P and Cl; wherein 0.5≦a≦1.5, 0≦y≦1,1≦b≦2.1, 0≦c≦0.5, 1≦n≦2.

2. The cathode material for secondary lithium batteries as stated in claim 1 is a composite structural material formed by compositing more than two different components selected from following two general formulas:
Liₐ₁M1_{1-y1)}M1′_{y1}O₂, general formula 1
wherein 0.95≦a1≦1.1, 0≦y1≦0.5; M1 is any one of Ni, Co or Mn, M1′ is any one of Co, Mn, Mg, Al, Ti and Zr or combinations of two or more than two of them; and
Liₐ₂M2_{(1-y2)}M2′_{y2}O₂, genreal formula 2
wherein 0.5≦a2≦1.5, 0≦y2≦1; M2 is any one of Ni, Co, Mn, Ti, V, Fe and Cr, M2′ is any one of Mg, Al, Ca, Sr, Zr, Ni, Co, Mn, Ti, V, Fe, Cr, Si, Na and K or combinations of two or more than two of them.

3. The cathode material for secondary lithium batteries as stated in claim 2, characterized in that: in said general formula 1 Liₐ₁M1_{(1-y1)}M1′_{y1}O₂, 0.95≦a1≦1.1, 0.05≦y1≦0.3, M1 is Ni, M1′ is Co_{1-z-m}Mn_{z}M1″ₘ, wherein M1″ is any one of Mg, Al, and Zr or combinations of two or more than two of them, 0≦z≦1,0≦m≦1, 0≦z+m≦1.

4. The cathode material for secondary lithium batteries as stated in claim 2, characterized in that: in said general formula 2 Liₐ₂M2_{(1-y2)}M2′_{y2}O₂, M2 is Ni, M2′ is Mn₁₋ₙ₂M2″ₙ₂, wherein M2″ is any one of Mg, Al, Ti and Zr or combinations of two or more than two of them, 0≦n2≦1, 0.95≦a2≦1.1, 0.3≦y2≦0.8.

5. The cathode material for secondary lithium batteries as stated in claim 4, characterized in that: in Liₐ₂M2_{(1-y2)}M2′_{y2}O₂, 0≦n2≦0.5, 0.5≦y2≦0.7.

6. The cathode material for secondary lithium batteries as stated in claim 2, characterized in that: the molar ratio of components in the said cathode material is: 0≦Σ[Liₐ₂M2_{(1-y2)}M2′_{y2}O₂]/Σ[Liₐ₁M1_{(1-y1)}M1′_{y1}O₂]≦200.

7. The cathode material for secondary lithium batteries as stated in claim 6, characterized in that: 0.25≦Σ[Liₐ₂M2_{(1-y2)}M2′_{y2}O₂]/Σ[Liₐ₁M1_{(1-y1)}M1′_{y1}O₂]≦4.

8. The cathode material for secondary lithium batteries as stated in claim 1, characterized in that: said more than two different components are following two components: LiNi_{0.8}Coₐ₁Mn_{0.1}O₂ and LiNi_{0.5}Mn_{0.5}O₂, or, LiNi_{0.8}Co_{0.1}Mn_{0.1}O₂ and LiNi_{0.45}Mg_{0.05}Mn_{0.5}O₂.

9. A precursor for making the cathode material for secondary lithium batteries as stated in claim 1, characterized in that:
a composite structural material formed by compositing more than two different components selected from a general formula of M_{1-y}M′_{y}(E)_{F}; said composite structures are formed between crystal clusters within primary particles and/or between primary particles; where the meanings of y, M and M′ are the same as in claim 1, E is an oxygen containing anion that can co-precipitate with M and M′; the value of F allows neutrality in the formula.

10. The precursor of the cathode material for secondary lithium batteries as stated in claim 9, characterized in that: E is hydroxy or carbonate; when E is hydroxy ion, F equals to b, and the meaning of b is the same as in claim 1.

11. The precursor of the cathode material for secondary lithium batteries as stated in claim 10, characterized in that:
said precursor is AM1_{(1-y1)}M1′_{y1}(OH)_{b1}-(1−A)M2_{(1-y2)M}2′_{y2}(OH)_{b2},
wherein A is a molar ratio of M1_{(1-y1)}M1′_{y1}(OH)_{b1} in the precursor, and 1−A is a molar ratio of M2_{(1-y2)}M2′_{y2}(OH)_{b2} in the precursor, 0<A<1, 0<(1−A)/A≦200, the meanings of y1, y2, M1, M1′, M2 and M2′are stated in claim 2; the meanings of b1 and b2 are the same as b in claims 1, b1 and b2 can be the same or different, or
said precursor is AM1_{(1-y1)}M1′_{y1}(CO₃)_{b1/2}-(1−A)M2_{(1-y2)}M2′_{y2}(CO₃)_{b2/2,}
wherein A is a molar ratio of M1_{(1-y1)}M1′₀(CO₃)_{b1/2} in the precursor, and 1−A is a molar ratio of M2_{(1-y2)}M2′_{y2}(CO₃)_{b2/2} in the precursor, 0<A<1, 0<(1A)/A≦200, the meanings of y1, y2, M1, M1′, M2 and M2′are stated in claim 2; the meanings of b1 and b2 are the same as b in claims 1, b1 and b2 can be the same or different.

12. The preparation method for making the precursor for the cathode material in claim 10, comprising the following steps:
according to chemical formulas of each individual components in more than two different components selected from a general formula [LiₐM_{1-y}M′_{y}O_{b}X_{c}]ₙ, hydroxides or carbonates corresponding to the each individual components are prepared, where the hydroxides or carbonates corresponding to each individual components are made of M and M′ cations in the chemical formula of each individual component; when these hydroxides or carbonates grow to the stage of forming crystal clusters and/or primary particles, all hydroxides or carbonates are mixed, and then to allow them to grow together to form primary particles and/or secondary particles.

13. The preparation method for making the precursor for the cathode material in claim 12, characterized in that:
method to prepare hydroxides corresponding to each individual components:
mixing the M salt solution and M′ salt solution for each individual components selected in a general formula of [LiₐM_{1-y}M′_{y}O_{b}X_{c}]ₙ with alkaline solution to take place precipitation reactions to form hydroxides corresponding to individual components;
method to prepare carbonates corresponding to each individual components:
mixing the M salt solution and M′ salt solution for each individual components selected in a general formula of [LiₐM_{1-y}M′_{y}O_{b}X_{c}]ₙ with alkaline carbonate solution to take place precipitation reactions to form carbonates corresponding to individual components.

14. The preparation method for making the precursor for the cathode material in claim 12, characterized in that: when preparing composite structures in the cathode material for secondary lithium batteries formed by composting different components represeted by general formula Liₐ₁M1_{(1-y1)}M1_{y1}O_{b1} and Liₐ₂M2₍₁₋₁₂)M2_{y2}O_{b2}, the method for preparation of precursor can be any one of following methods:
In following methods, M1 and M1′ salt solution is metal salt solution I, and M2 and M2′ salt solution is metal salt solution II;
Method 1: Within time t₁ add a portion of metal salt solution I into alkaline solution or alkaline carbonate solution with pre-determined pH value and temperature T, while alkaline solution or alkaline carbonate solution is also added to keep the pH value of the system. The reaction time is t₁ₘ. Within time t₂ add a portion of metal salt solution II into alkaline solution or alkaline carbonate solution with pre-determined pH value and temperature T, while alkaline solution or alkaline carbonate solution is also added to keep the pH value of the system. The reaction time is t₂ₘ. Repeat these procedures till all salt solution is completely added into the system. Then allow it to react for time tₑ, followed by ripening for time tₛ. The reactant is filtered, dried. The precursor AM1_{(1-y1)}M1′_{y1}(OH)_{b1}-(1−A)M2_{(1-y2)}M2′_{y2}(OH)_{b2} or AM1_{(1-y1)}M1′_{y1}(CO₃)_{b1/2}-(1−A)M2_{(1-y2)}M2′_{y2}(CO₃)_{b2/2} is obtained.
Method 2: Add metal salt solution I and metal salt solution II into alkaline solution or alkaline carbonate solution with pre-determined pH value and temperature T respectively, while add alkaline solution or alkaline carbonate solution to both systems to keep the pH value. Two reactant solutions Ir and Ilr are obtained. After allowing solution Ir to react for time tₘ and solution Ilr to react for tₘ′, mix them together to have a mixture. The mixture reacts for time tₑ with the pH value and temperature T, followed by ripening for time tₛ. The mixture is filtered and then dried. The precursor AM1_{(1-y1)}M1′_{y1}(OH)_{b1}-(1−A)M2_{(1-y2)}M2′_{y2}(OH)_{b2} or AM1_{(1-y1)}M1′_{y1}(CO₃)_{b1/2}-(1−A)M2_{(1-y2)}M2′_{y2}(CO₃)_{b2/2} is obtained. p1 wherein A is a molar ratio of M1_{(1-y1)}M1′_{y1}(OH)_{bi} in the precursor, and 1−A is a molar ratio of M2_{(1-y2)}M2′_{y2}(OH)_{b2} in the precursor, 0<(1−A)/A≦200, the meaning b1 and b2 are the same as b in claims 1, b1 and b2 can be the same or different; the meanings of y1, y2, M1, M1′, M2 and M2′are stated in claim 2; (t₁+tₘ), (t₂+t₂ₘ), tₘ and tₘ′ are not over 480 minutes, tₑ in the range of 1-8 hours; tₛ in the range of 6-48 hours; and the pH value is in the range of 9-12, the range of T is in 25-70° C.

15. The preparation method for making the precursor for the cathode material as stated in claim 14, characterized in that: (t₁+tₘ), (t₂+t₂ₘ), tₘ and tₘ′ are not over 240 minutes, tₑ in the range of 2-6 hours; tₛ in the range of 12-36 hours; and the pH value is in the range of 11-12, the range of T is in 45-55° C., 0.25≦(1−A)/A≦4; said salt solutions are sulfonate solutions, nitrate solution and oxalate solutions; the said alkaline solution is alkali metal hydroxides solution; said alkaline carbonate solution is alkali metal carbonate solution or alkali metal hydrogen carbonate solution.

16. The preparation method for making the precursor for the cathode material as stated in claim 15 with characteristics of: (t₁+tₘ), (t₂+t₂ₘ), tₘ and tₘ′ are not over 30 minutes.

17. A preparation method for making the cathode material for secondary lithium batteries includes following steps:
(1) making a precursor according to a method described in claim 12 ;
(2) Mixing the precursor in procedure (1) with lithium hydroxide or lithium salts, then sintering; the cathode material is made.

18. The preparation method for making the cathode material for secondary lithium batteries as stated in claim 17, characterized in that: procedure (2) is as follows:
mixing the precursor made in procedure (1) with lithium hydroxide or lithium salts homogenously, sintering at temperature T_{c} for time t_{c} under oxygen containing atmosphere; after cooling down and milling, the cathode material is derived. The said T_{c} is in the range of 600-950° C., and t_{c} is in the range of 6-48 hours.

19. The preparation method for making the cathode material for secondary lithium batteries as stated in claim 18, characterized in that: said T_{c} is in the range of 700-850° C., and t_{c} is in the range of 8-20 hours.

20. The preparation method for making the cathode material for secondary lithium batteries as stated in claim 17, characterized in that: said lithium salt is lithium carbonate or lithium nitrate; a molar ratio of lithium ions in lithium hydroxide or lithium salts and the total transition metal ions is in the range of 0.5 to 1.5.

21. The preparation method for making the cathode material for secondary lithium batteries as stated in claim 20, characterized in that: the molar ratio of lithium ions in lithium hydroxide or lithium salts and the total transition metal ions is in the range of 0.95 to 1.1.

22. A secondary lithium battery comprising the a cathode material for secondary lithium batteries in stated claim 1.
